(19) United States
(12) Patent Application Publication
(10) Pub. No.: US 2024/0190203 A1
(43) Pub. Date: Jun. 13, 2024

(54) THERMAL MANAGEMENT FLUID MODULE FOR VEHICLE

(71) Applicant: Hanon Systems, Daejeon (KR)

(72) Inventors: In Keun KANG, Daejeon (KR); Young Man KIM, Daejeon (KR); Kyeong Cheol LEE, Daejeon (KR); Jae Min LEE, Daejeon (KR); Chan Jin LEE, Daejeon (KR)

(21) Appl. No.: 18/533,525

(22) Filed: Dec. 8, 2023

(30) Foreign Application Priority Data
Dec. 8, 2022 (KR) 10-2022-0170500
Dec. 22, 2022 (KR) 10-2022-0181300

(51) Int. Cl. B60H 1/00

(52) U.S. Cl. CPC B60H 1/00342; B60H 1/00278; B60H 2001/00307; B60K 11/02

(57) ABSTRACT

A thermal management fluid module for a vehicle according to one embodiment of the present invention includes a manifold plate, in which a fluid passage is formed in one surface of the manifold plate and the fluid passage is formed along one passage layer, and a valve which is coupled to another surface of the manifold plate and expands a fluid or controls a flow direction of the fluid, wherein the valve is disposed on a layer different from the passage layer of the fluid passage and can communicate with the fluid passage.

### CROSS-REFERENCE TO RELATED APPLICATION

This application claims priority to and the benefit of Korean Patent Application No. 10-2022-0170500, filed on Dec. 8, 2022 and Korean Patent Application No. 10-2022-0181300, filed on Dec. 22, 2022, the disclosure of which is incorporated herein by reference in its entirety.

### BACKGROUND

### 1. Field of the Invention

The present invention relates to a thermal management fluid module for a vehicle, and more specifically, to a thermal management fluid module for a vehicle, in which a heat exchanger and valve components are modularized into one part.

### 2. Discussion of Related Art

Under the trend of the development of eco-friendly industries and energy sources that replace fossil raw materials, electric vehicle and hybrid vehicle fields recently have mostly drawn attention in the vehicle industry. In electric vehicles and hybrid vehicles, batteries are mounted to provide a driving force, and the batteries are used not only for driving but also for cooling and heating.

In a vehicle in which a driving force is provided using a battery, the fact that the battery is used as a heat source during cooling and heating means that a driving distance is reduced accordingly. In order to overcome the above problem, a method of applying a thermal management system, which has been widely used as a home air conditioning system, to a vehicle is proposed.

For reference, a thermal management system is a system configured to absorb low-temperature heat and change the absorbed heat to high-temperature heat. As an example, a thermal management system has a cycle in which a liquid fluid evaporates in an evaporator, absorbs heat from its surroundings, and becomes a gas, and then the gas is liquefied while emitting the heat to its surroundings through a condenser. When the thermal management system is applied to an electric vehicle or hybrid vehicle, there is an advantage of securing a heat source that is insufficient in the conventional air conditioning apparatus.

Nowadays, in a modularized structure of a thermal management system for an electric vehicle, main components (a valve, an accumulator, a chiller, a condenser, an internal heat exchanger, and a sensor) are connected by piping as a partial modularization method. In a process of developing such a thermal management system for a vehicle, the development of a technology for optimizing modularization through appropriate placement of the components and improvement of a coolant passage is required.

### SUMMARY OF THE INVENTION

The present invention is directed to providing a thermal management fluid module for a vehicle, in which both a ball-type direction change valve (3-way valve) and a needle-type expansion valve are mounted on a manifold plate.

In addition, the present invention is also directed to providing a thermal management fluid module for a vehicle with a structure that maintains airtightness because a valve mounted on a manifold plate does not interfere with a fluid passage formed in a manifold.

In addition, the present invention is also directed to providing a thermal management fluid module for a vehicle, of which the space efficiency is improved by appropriately designing an entrance and exit structure through which a fluid inflows according to a type (ball type or needle type) of a valve.

In addition, the present invention is also directed to providing a thermal management fluid module for a vehicle optimized by forming coolant passages on one surface and the other surface of a manifold plate and arranging a heat exchanger, a valve, and the like on the coolant passages.

In addition, the present invention is also directed to providing a thermal management fluid module for a vehicle that, since valves disposed on both surfaces of a manifold plate communicate to allow a fluid to directly flow therebetween so that a shortest coolant passage is formed, the pressure loss and thermal interference between passages can be minimized to prevent thermal management performance degradation.

In addition, the present invention is also directed to providing a thermal management fluid module for a vehicle, in which a coolant passage is formed to allow a coolant to flow in a gravity direction to prevent a coolant and oil from remaining in a manifold plate.

According to an aspect of the present invention, there is provided a thermal management fluid module for a vehicle including a manifold plate, in which a fluid passage is formed in one surface of the manifold plate and the fluid passage is formed along one passage layer, and a valve which is coupled to another surface of the manifold plate and expands a fluid or controls a flow direction of the fluid, wherein the valve is disposed on a layer different from the passage layer of the fluid passage and communicates with the fluid passage.

The valve may be disposed in a layer above the passage layer of the fluid passage.

The thermal management fluid module for a vehicle may further include a heat exchanger which is coupled to the manifold plate and exchanges heat between a coolant and cooling water.

The valve may be a ball-type direction change valve which controls a flow direction of the coolant flowing out of the heat exchanger, and the direction change valve may be coupled to a first valve seating part formed on the layer above the passage layer on the one surface of the manifold plate.

A first inlet hole through which the coolant flowing through the fluid passage flows may be formed in a bottom surface of the first valve seating part, and a first outlet hole through which the coolant flowing into the direction change valve outflows may be formed in a side surface of the first valve seating part.

A flange part may be provided on the direction change valve, and the flange part may be fastened to a valve fastening part formed on an upper end of the first valve seating part.

The valve may be an expansion valve which expands the coolant flowing into the heat exchanger; and

The expansion valve may be coupled to a second valve seating part formed on the layer above the passage layer in the one surface of the manifold plate.

A second inlet hole through which the coolant flows into the expansion valve may be formed in a side surface of the second valve seating part.

A second outlet hole through which the coolant flowing into the expansion valve outflows may be formed in a bottom surface of the second valve seating part.

According to another aspect of the present invention, there is provided a thermal management fluid module for a vehicle including a manifold plate in which a passage through which a fluid flows is formed and valves which are coupled to one surface and the other surface of the manifold plate and expand the fluid or control a flow direction of the fluid, wherein the valve coupled to the one surface of the manifold plate communicates with the valve coupled to the other surface of the manifold plate so that the fluid flowing out of the valve coupled to the one surface directly flows into the valve coupled to the other surface.

The manifold plate may include a main plate, a first plate which is coupled to one surface of the main plate and in which a passage through which the fluid flows is formed, and a second plate which is coupled to the other surface of the main plate and in which a passage through which the fluid flows is formed, wherein a communication hole for passage communication between the valves coupled to the first plate and the second plate may be formed in the main plate.

The second plate may be coupled to a first heat exchanger in which the fluid flows to perform heat exchange and a first expansion which expands or passes the fluid flowing into the first heat exchanger.

The first plate may be coupled to a second heat exchanger in which the fluid flows to perform heat exchange, a first direction change valve and a second direction change valve which control a flow direction of the fluid flowing out of the first heat exchanger, and a second expansion valve which expands the fluid flowing into the second heat exchanger.

The second plate may be coupled to a first heat exchanger in which a high-temperature fluid flows, and the first plate may be coupled to a second heat exchanger in which a low-temperature fluid flows.

The first heat exchanger may be a water-cooled condenser, and the second heat exchanger may be a chiller.

The first expansion valve and the first direction change valve may be disposed to be horizontally collinear on the manifold plate.

A sensor which measures a temperature and a pressure of a coolant may be disposed on a passage through which the coolant flowing out of the second heat exchanger flows.

An entrance hole through which the coolant flows into the second heat exchanger, an exit hole through which the coolant outflows, and a sensor insertion hole into which the sensor is inserted may be disposed in a gravity direction.

The sensor may be coupled to the one surface, which is the same as a surface coupled to the second heat exchanger, of the manifold plate.

The second heat exchanger may be coupled to the one surface of the manifold plate, and the sensor may be coupled to a side surface of the manifold plate.

An accumulator port through which the fluid outflows to an accumulator may be formed in a lowermost end of the manifold plate in the gravity direction.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a front perspective view illustrating a thermal management fluid module for a vehicle according to one embodiment of the present invention;

FIG. 2 is a perspective view illustrating a first valve seating part formed in the thermal management fluid module for a vehicle according to one embodiment of the present invention;

FIG. 3 is a cross-sectional view illustrating a direction change valve mounted in the thermal management fluid module for a vehicle according to one embodiment of the present invention;

FIG. 4 is a cross-sectional view illustrating an expansion valve mounted in the thermal management fluid module for a vehicle according to one embodiment of the present invention;

FIG. 5 is a perspective view illustrating a thermal management fluid module for a vehicle according to another embodiment of the present invention;

FIG. 6 is an exploded perspective view illustrating a manifold plate of the thermal management fluid module for a vehicle according to another embodiment of the present invention;

FIG. 7 is a rear view illustrating the manifold plate of the thermal management fluid module for a vehicle according to another embodiment of the present invention;

FIG. 8 is a perspective view illustrating a second plate of the thermal management fluid module for a vehicle according to another embodiment of the present invention;

FIG. 9 is a perspective view illustrating a first heat exchanger of the thermal management fluid module for a vehicle according to another embodiment of the present invention;

FIG. 10 is a front view illustrating a thermal management fluid module for a vehicle according to another embodiment of the present invention;

FIG. 11 is a side view illustrating the thermal management fluid module for a vehicle according to another embodiment of the present invention;

FIG. 12 is a view illustrating a fluid passage between valves in the thermal management fluid module for a vehicle according to another embodiment of the present invention;

FIG. 13 is a perspective view illustrating a second heat exchanger of the thermal management fluid module for a vehicle according to another embodiment of the present invention; and

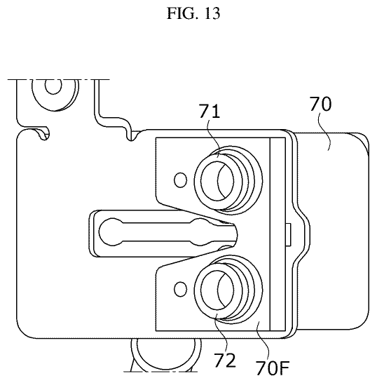

FIG. 14 is a view illustrating a sensor mounted on a manifold plate of the thermal management fluid module for a vehicle according to another embodiment of the present invention.

### DETAILED DESCRIPTION OF EXEMPLARY EMBODIMENTS

Since the present invention may be modified in various ways and have numerous embodiments, specific embodiments will be illustrated in the accompanying drawings and described in the detailed description. However, this is not intended to limit the present invention to the specific embodiments, and it is to be appreciated that all changes, equivalents, and substitutes falling within the spirit and technical scope of the present invention are encompassed in the present invention. In the description of the embodiments, certain detailed descriptions of the related art are omitted when it is deemed that they may unnecessarily obscure the gist of the inventive concept.

While terms such as “first” and “second” may be used to describe various components, such components are not limited by the above terms. The terms are used only to distinguish one component from another.

The terminology used herein is for the purpose of describing particular embodiments only and is not intended to limit the present invention. The singular forms are intended to include the plural forms, unless the context clearly indicates otherwise. In the present specification, it should be understood that the terms “comprise,” “comprising,” “include,” and/or “including” used herein specify the presence of stated features, numbers, steps, operations, elements, components, and/or combinations thereof but do not preclude the presence or addition of one or more other features, numbers, steps, operations, elements, components, and/or combinations thereof.

In addition, throughout the specification, when components are “connected,” this may not only mean that two or more components are directly connected, but this may also mean that two or more components are indirectly connected through other components or are physically connected as well as electrically connected, or are one part even referred to as different names according to positions or functions thereof.

Hereinafter, when a thermal management fluid module for a vehicle according to the present invention is described in detail with reference to the accompanying drawings, components that are the same or correspond to each other will be denoted by the same reference numerals, and redundant description will be omitted.

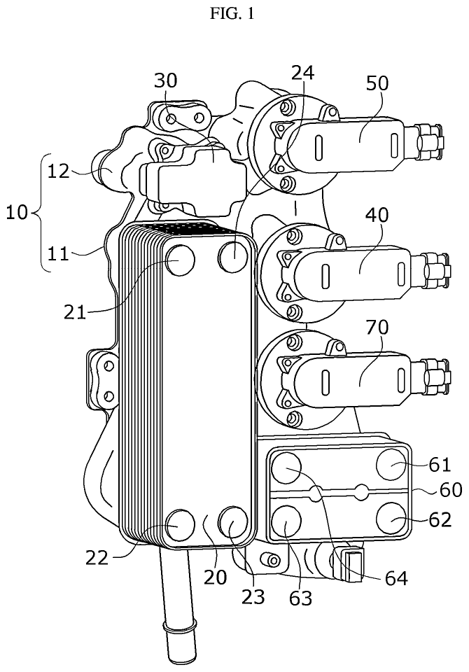

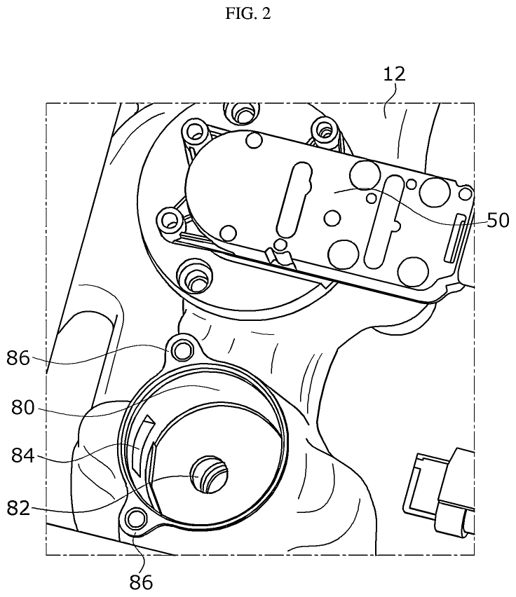

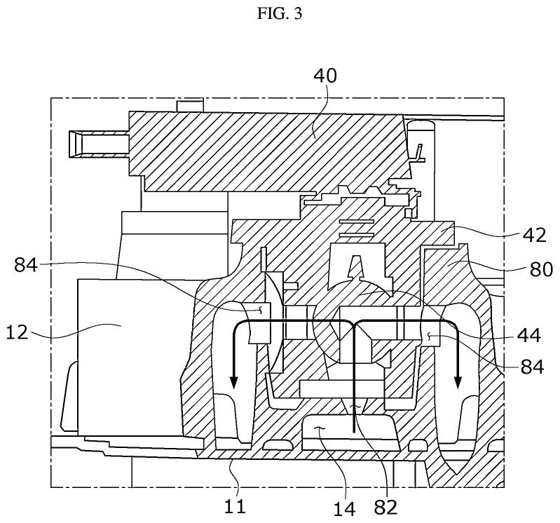

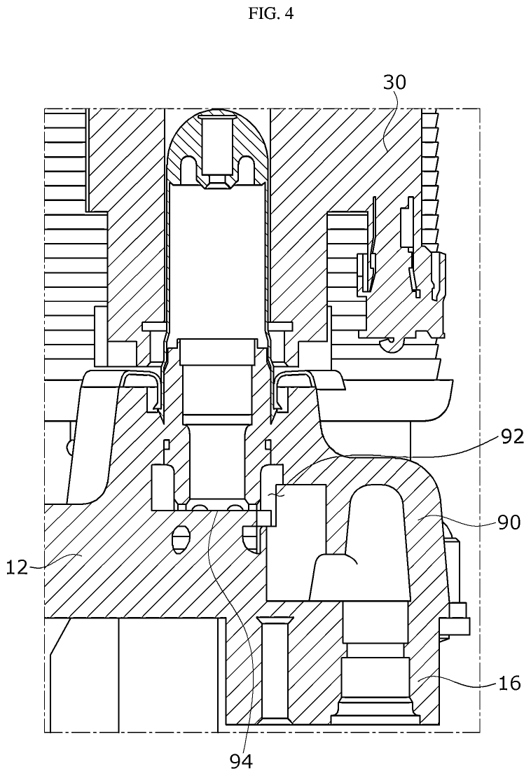

FIG. 1 is a front perspective view illustrating a thermal management fluid module for a vehicle according to one embodiment of the present invention, and FIG. 2 is a perspective view illustrating a first valve seating part formed in the thermal management fluid module for a vehicle according to one embodiment of the present invention. FIG. 3 is a cross-sectional view illustrating a direction change valve mounted in the thermal management fluid module for a vehicle according to one embodiment of the present invention, and FIG. 4 is a cross-sectional view illustrating an expansion valve mounted in the thermal management fluid module for a vehicle according to one embodiment of the present invention.

According to the illustrated drawings, the thermal management fluid module for a vehicle according to one embodiment of the invention may include a manifold plate 10 in which a fluid passage 14 is formed in one surface thereof along one passage layer and a valve which is coupled to one surface of the manifold plate 10 and expands a fluid or controls a flow direction of the fluid, and the valve may be disposed on a layer different from the passage layer and communicate with the fluid passage 14.

The fluid passage 14 is formed in the manifold plate 10, and the manifold plate 10 has a plate shape having a predetermined thickness. As described above, a first heat exchanger 20 and a second heat exchanger 60, which are heat exchange apparatuses of a thermal management system, expansion valves 30 and 70, and direction change valves 40 and 50 are modularized by being coupled on the manifold plate 10. Accordingly, product manufacturing man-hours can be reduced, and man-hours of a vehicle assembly line can also be reduced. In addition, since the manifold plate 10 can serve all functions of piping, fitting, and housing, costs can be reduced, and workability can be improved.

The manifold plate 10 may include an assembly including a bottom plate 11 and a top plate 12 and may be manufactured through a method of coupling using brazing, a structural adhesive, a gasket, or the like. In addition, any of various materials such as aluminum, thermo-plastic, or stainless steel may be used as a material of the manifold plate 10 according to a manufacturing method, a purpose, and a function.

The bottom plate 11 is formed in a plate shape, and the top plate 12 is coupled to one surface of the bottom plate 11 to protrude to a predetermined thickness to form the fluid passage 14 between the bottom plate 11 and the top plate 12. In this case, the fluid passage 14 may be formed as one passage layer. One passage layer means that the fluid passage 14 extends generally along one layer. That is, the fluid passage 14 may extend along one passage layer without extending along a plurality of passage layers in the manifold plate 10.

The first heat exchanger 20 and the second heat exchanger 60 as heat exchange apparatuses are coupled to the manifold plate 10. Heat exchange may be performed while the coolant and cooling water pass through the first heat exchanger 20 and the second heat exchanger 60.

In the present embodiment, a water-cooled condenser may be used as the first heat exchanger 20, and a chiller may be used as the second heat exchanger 60. The water-cooled condenser serves to condense a high-temperature high-pressure gaseous fluid (coolant) discharged from a compressor or internal condenser into a high-pressure liquid by exchanging heat with an external heat source. The chiller is an apparatus in which a low-temperature low-pressure fluid is supplied and exchanges heat with cooling water moving along a cooling water circulation line (not shown), and cold cooling water heat-exchanged in the chiller may circulate along the cooling water circulation line and exchange heat with a battery.

Coolant ports through which the coolant inflows and outflows are provided in the first heat exchanger 20. The coolant ports include a first coolant inlet hole 21 and a first coolant outlet hole 22 provided in an upper end and a lower end of the first heat exchanger 20, respectively. The first coolant inlet hole 21 is a hole through which the coolant passing through a first expansion valve 30 inflows, and the first coolant outlet hole 22 is a hole through which the coolant heat-exchanged in the first heat exchanger 20 outflows. The first coolant inlet hole 21 and the first coolant outlet hole 22 each may be formed in a hole shape in each of the upper end and the lower end of the first heat exchanger 20.

In this case, in consideration of thermal interference, the first coolant inlet hole 21 may be formed at one side close to the first expansion valve 30, and the first coolant outlet hole 22 may be formed at the other side far from the first expansion valve 30. More specifically, the first coolant inlet hole 21 may be disposed closer to the first expansion valve 30 than the first coolant outlet hole 22. For example, a distance from the first expansion valve 30 to the first coolant inlet hole 21 may be smaller than a distance from the first expansion valve 30 to the first coolant outlet hole 22.

In addition, cooling water ports through which the cooling water inflows and outflows are formed in the first heat exchanger 20. The cooling water ports include a first cooling water inlet hole 23 and a first cooling water outlet hole 24 provided in the lower end and the upper end of the first heat exchanger 20. The first cooling water inlet hole 23 is a hole through which the cooling water inflows, and the first cooling water outlet hole 24 is a hole through which the cooling water heat-exchanged with the coolant outflows. The cooling water exchanges heat with the coolant while flowing in a direction (from a lower portion to an upper portion) opposite to a flow direction of the coolant.

Since the coolant ports and the cooling water ports described above are disposed separately from each other, the assemblability of coolant piping and cooling water piping can be improved.

The first expansion valve 30 serves to control expansion of the coolant flowing into the first heat exchanger 20. The first expansion valve 30 may be disposed above the first heat exchanger 20 and may expand or pass the coolant inflowing from the compressor. The coolant inflowing through the first expansion valve 30 may exchange heat while passing through the first heat exchanger 20 or may move to an external heat exchanger.

The coolant outflowing through the first coolant outlet hole 22 of the first heat exchanger 20 flows into a first direction change valve 40. The first direction change valve 40 serves to control a flow direction of the coolant flowing out of the first heat exchanger 20. The coolant flowing into the first direction change valve 40 may move to the external heat exchanger. In addition, the coolant flowing into the first expansion valve 30 may move to a second direction change valve 50 in a dehumidification mode and then move to an evaporator (not shown).

A low-temperature low-pressure coolant is supplied to the second heat exchanger 60 and exchanges heat with the cooling water moving along the cooling water circulation line (not shown). The cold cooling water heat-exchanged in the second heat exchanger 60 may exchange heat with the battery by circulating along the cooling water circulation line. The coolant heat-exchanged with the external heat exchanger flows into the second expansion valve 70, and the coolant expanding in the second expansion valve 70 flows into the second heat exchanger 60. The coolant heat-exchanged in the second heat exchanger 60 outflows through a lower end thereof and flows into an accumulator (not shown).

To this end, coolant ports through which the coolant inflows and outflows are provided in the second heat exchanger 60. The coolant ports include a second coolant inlet hole 61 and a second coolant outlet hole 62 provided in an upper end and the lower end of the second heat exchanger 60, respectively. The second coolant inlet hole 61 is a hole through which the coolant inflows, and the second coolant outlet hole 62 is a hole through which the coolant heat-exchanged in the second heat exchanger 60 outflows. The second coolant inlet hole 61 and the second coolant outlet hole 62 each may be formed in a hole shape in each of the upper end and the lower end of the second heat exchanger 60.

A second cooling water inlet hole 63 and a second cooling water outlet hole 64 are provided in the second heat exchanger 60. The cooling water inflowing through the second cooling water inlet hole 63 exchanges heat with the coolant and then outflows through the second cooling water outlet hole 64.

In this case, in consideration of thermal interference, the second coolant inlet hole 61 of the second heat exchanger 60 may be formed at one side close to the second expansion valve 70, and the second coolant outlet hole 62 may be formed at the other side far from the second expansion valve 70. More specifically, the second coolant inlet hole 61 may be disposed closer to the second expansion valve 70 than the second coolant outlet hole 62. For example, a distance from the second expansion valve 70 to the second coolant inlet hole 61 may be smaller than a distance from the second expansion valve 70 to the second coolant outlet hole 62.

Referring to FIGS. 2 and 3, a first valve seating part 80 is formed on an upper layer of the passage layer of the fluid passage 14 at a side of one surface of the manifold plate 10, that is, one surface to which the top plate 12 is coupled. In this case, the first valve seating part 80 may be disposed on a layer different from the passage layer of the fluid passage 14 but is not necessarily disposed on the upper layer. The first direction change valve 40 and the second direction change valve 50 may be seated on and coupled to the first valve seating part 80. Hereinafter, an example of the first direction change valve 40 will be described.

The first valve seating part 80 may be formed on the upper layer of the passage layer in which the fluid passage 14 is formed. That is, as the fluid passage 14 is formed on a first layer on one surface of the manifold plate 10, and the first valve seating part 80 is formed on a second layer thereof, the fluid passage 14 and the first direction change valve 40 may be disposed not to interfere with each other. As described above, when the first direction change valve 40 is disposed on the upper layer, since the fluid passage 14 is independently formed on one passage layer, the airtightness of the manifold plate 10 can be maintained.

The first valve seating part 80 may be formed in a substantially cylindrical shape corresponding to a shape of the first direction change valve 40. In the present embodiment, a 3-way valve may be used as the first direction change valve 40. Since the coolant inflows through a lower end of the first direction change valve 40 and outflows through two sides thereof, a first inlet hole 82 and a first outlet hole 84 are formed in the corresponding first valve seating part 80.

As the first inlet hole 82 is formed in a bottom surface of the first valve seating part 80, the coolant flowing through the fluid passage 14 may inflow. That is, the coolant flowing through the fluid passage 14 flows into the first direction change valve 40 disposed thereabove through the first inlet hole 82. In addition, the first outlet hole 84 is formed in each of two side surfaces of the first valve seating part 80 so that the coolant flowing into the first direction change valve 40 may outflow. In a state in which the first direction change valve 40 is coupled to the first valve seating part 80 described above, the coolant may flow into a lower portion of the first direction change valve 40 and then outflow through two sides.

Meanwhile, a flange part 42 to be fastened to the manifold plate 10 may be provided on an upper portion of the first direction change valve 40. The flange part 42 may be formed in a disk shape on the upper portion of the first direction change valve 40 and fastened to a plurality of valve fastening parts 86 formed in an upper end of the first valve seating part 80 using bolts and the like. In this case, it is described that the flange part 42 is fastened to the valve fastening parts 86, but is not limited thereto, and the flange part 42 may also be directly fastened to an upper surface of the manifold plate 10. In addition, a ball 44 for controlling a flow direction of the coolant is mounted in the first direction change valve 40.

Referring to FIG. 4, a second valve seating part 90 is formed on the upper layer of the passage layer of the fluid passage 14 at a side of one surface of the manifold plate 10, that is, one surface to which the top plate 12 is coupled. The expansion valve 30 may be seated on and coupled to the second valve seating part 90.

The second valve seating part 90 may be formed on the upper layer of the passage layer in which the fluid passage 14 is formed. That is, as the fluid passage 14 is formed on the first layer on one surface of the manifold plate 10, and the second valve seating part 90 is formed on the second layer, the fluid passage 14 and the expansion valve 30 may be disposed not to interfere with each other. As described above, when the expansion valve 30 is disposed on the upper layer, since the fluid passage 14 is independently formed on one passage layer, the airtightness of the manifold plate 10 can be maintained. As a result, since the valves disclosed in the present embodiment are disposed on the layer separate from the passage layer of the fluid passage 14 formed on one surface of the manifold plate 10, the fluid passage 14 can be independently formed, and thus the airtightness of the manifold plate 10 can be maintained.

The expansion valve 30 may expand the coolant inflowing through a fluid inlet port 16 provided in one surface of the manifold plate 10 and transfer the coolant to the fluid passage 14. To this end, a second inlet hole 92 through which the coolant inflows is formed in a side surface of the second valve seating part 90. In addition, a second outlet hole 94 through which the coolant flowing into the expansion valve 30 outflows is formed in a bottom surface of the second valve seating part 90.

In the present embodiment, a needle-type valve may be used as the expansion valve 30, and the second valve seating part 90 may also be formed in a cylindrical shape corresponding to a shape of the expansion valve 30. In addition, according to a method of controlling the needle-type expansion valve 30, the coolant may inflow through a side surface of the expansion valve 30 and then outflows through a lower end thereof

As described above, since all the ball-type direction change valves 40 and 50 and the needle-type expansion valve 30 can be mounted on the manifold plate 10, the thermal management fluid module for a vehicle can be packaged, the product workability can be improved, and costs thereof can be reduced. In addition, since the valves mounted on the manifold plate 10 do not interfere with the fluid passage 14 formed in the manifold, the airtightness of the thermal management fluid module for a vehicle can be maintained. In addition, the space efficiency of the thermal management fluid module for a vehicle can be improved by appropriately designing an entrance and exit structure through which the fluid inflows according to a type (ball type or needle type) of valve.

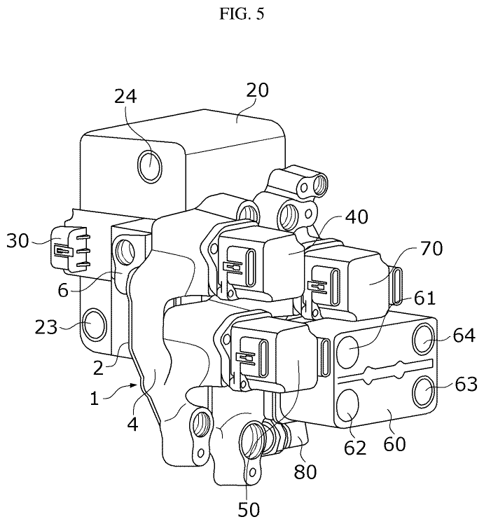

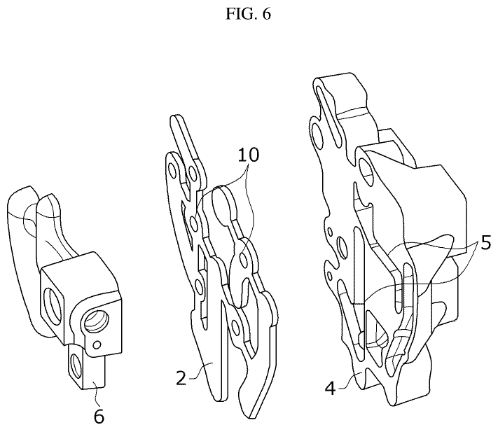

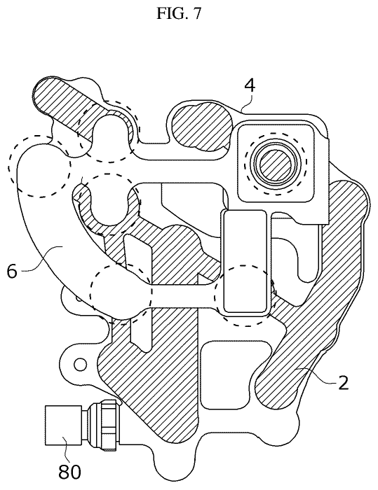

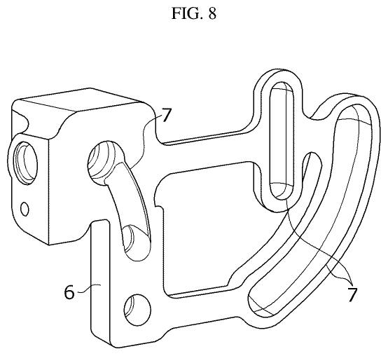

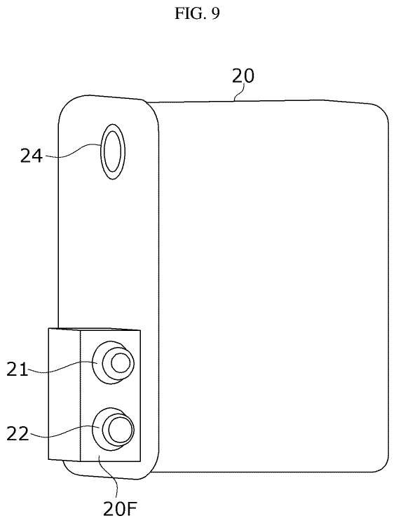

FIG. 5 is a perspective view illustrating a thermal management fluid module for a vehicle according to another embodiment of the present invention, and FIG. 6 is an exploded perspective view illustrating a manifold plate of the thermal management fluid module for a vehicle according to another embodiment of the present invention. FIG. 7 is a rear view illustrating the manifold plate of the thermal management fluid module for a vehicle according to another embodiment of the present invention, and FIG. 8 is a perspective view illustrating a second plate of the thermal management fluid module for a vehicle according to another embodiment of the present invention. FIG. 9 is a perspective view illustrating a first heat exchanger of the thermal management fluid module for a vehicle according to another embodiment of the present invention.

According to the illustrated drawings, the thermal management fluid module for a vehicle according to one embodiment of the invention may include a manifold plate 101 in which a passage through which a fluid flows is formed and valves which are coupled to one surface and the other surface of the manifold plate 101 and expand the fluid or control a flow direction of the fluid, and the valve coupled to one surface of the manifold plate 101 may communicate with the valve coupled to the other surface of the manifold plate 101 so that the fluid flowing out of the valve coupled to one surface of the manifold plate 101 directly flows into the valve coupled to the other surface of the manifold plate 101.

The manifold plate 101 has substantially a plate shape in which a fluid passage is formed to have a predetermined thickness. As described above, a first heat exchanger 120 and a second heat exchanger 160 which are heat exchange apparatuses of a thermal management system, expansion valves 130 and 170, and direction change valves 140 and 150, are modularized by being coupled in the manifold plate 101.

Accordingly, product manufacturing man-hours can be reduced, and man-hours of a vehicle assembly line can also be reduced. In addition, since the manifold plate 101 can serve all functions of piping, fitting, and housing, costs can be reduced, and workability can be improved.

Referring to FIG. 6, the manifold plate 101 may include a main plate 102, a first plate 104 which is coupled to one surface of the main plate 102 and in which a first passage 105 through which the fluid flows is formed, and a second plate 106 which is coupled to the other surface of the main plate 102 and in which a second passage 107 through which the fluid flows is formed. The manifold plate 101 may include an assembly including the above-described plates and may be manufactured through a coupling method using brazing, a structural adhesive, a gasket, or the like. In addition, any of various materials such as aluminum, thermo-plastic, or stainless steel may be used as a material of the manifold plate 101 according to a manufacturing method, a purpose, and a function.

The main plate 102 may be formed in a plate shape, the first plate 104 may be coupled to one surface of the main plate 102, and the second plate 106 may be coupled to the other surface thereof. The first plate 104 and the second plate 106 are coupled to protrude to a predetermined thickness to form a fluid passage between the first plate 104 and the second plate 106 and the main plate 102. Due to the manifold plate 101 formed by the coupling, since heat exchangers, valves, and the like may be coupled to both surfaces of the main plate 102 and a fluid passage may be formed, components can be modularized in a more compact space.

Referring to FIGS. 6 to 8, the first passage 105 through which a coolant flows may be formed in the first plate 104, and the second passage 107 through which the coolant flows may be formed in the second plate 106. Accordingly, the coolant can flow in the first plate 104 and the second plate 106 disposed at both sides of the main plate 102.

A communication hole 110 for passage communication may be formed between valves coupled to the first plate 104 and the second plate 106 in the main plate 102. The communication hole 110 may be formed in any portion other than a portion illustrated in the drawings as long as coolant passages between valves communicate.

Referring to FIG. 5 again, the first heat exchanger 120 and a first expansion valve 130 are coupled to one surface (left surface in the drawings) of the manifold plate 101, and the second heat exchanger 160, a first direction change valve 140, a second direction change valve 150, and a second expansion valve 170 are coupled to the other surface (right surface in the drawings) thereof. That is, the second heat exchanger 160, the first direction change valve 140, and the second direction change valve 150 are coupled to the first plate 104, and the first heat exchanger 120 and the first expansion valve 130 are coupled to the second plate 104.

A passage through which the coolant outflowing after heat exchanging in the first heat exchanger 120 flows into the first direction change valve 140 may be a high-temperature passage, and a passage through which the coolant heat-exchanged in the second heat exchanger 160 outflows may be a low-temperature passage. However, as described above, when the first heat exchanger 120 and the second heat exchanger 160 are disposed on one surface and the other surface of the manifold plate 101, respectively, since the high-temperature passage and the low-temperature passage may be disposed to be spaced apart from each other, thermal interference can be minimized.

The coolant and cooling water may pass through the first heat exchanger 120 and the second heat exchanger 160, respectively, to exchange heat with each other. In the present embodiment, the heat exchangers and the valves are disposed as described above but are not limited thereto. For example, only a heat exchanger may be coupled to one surface of the manifold plate 101, and only a valve may be coupled to the other surface thereof.

In the present embodiment, a water-cooled condenser may be used as the first heat exchanger 120, and a chiller may be used as the second heat exchanger 160. The water-cooled condenser serves to condense a high-temperature high-pressure gaseous fluid (coolant) discharged from a compressor or internal condenser into a high-pressure liquid by exchanging heat with an external heat source. The chiller is an apparatus in which a low-temperature low-pressure fluid is supplied and exchanges heat with cooling water flowing along a cooling water circulation line (not shown). The cold cooling water heat-exchanged in the chiller may circulate along the cooling water circulation line and exchange heat with a battery.

Referring to FIG. 9, coolant ports through which the coolant inflows and outflows are provided in the first heat exchanger 120. The coolant ports include a first coolant inlet hole 121 and a first coolant outlet hole 122 provided at an upper end and a lower end of the first heat exchanger 120, respectively. The first coolant inlet hole 121 is a hole through which the coolant passing through the first expansion valve 130 inflows, and the first coolant outlet hole 122 is a hole through which the coolant heat-exchanged in the first heat exchanger 120 outflows.

In the present embodiment, the first coolant inlet hole 121 and the first coolant outlet hole 122 may be formed in a first coolant flange 120F integrally formed on one side of the first heat exchanger 120. As the first coolant inlet hole 121 is disposed at a higher level than the first coolant outlet hole 122, the coolant may flow in a gravity direction. Accordingly, a trapping phenomenon that the coolant and oil remain in the thermal management fluid module can be prevented.

In this case, in consideration of thermal interference, the first coolant inlet hole 121 may be formed at one side close to the first expansion valve 130, and the first coolant outlet hole 122 may be formed at the other side far from the first expansion valve 130. More specifically, the first coolant inlet hole 121 may be disposed closer to the first expansion valve 130 than the first coolant outlet hole 122. For example, a distance from the first expansion valve 130 to the first coolant inlet hole 121 may be smaller than a distance from the first expansion valve 130 to the first coolant outlet hole 122.

Referring to FIG. 5 again, cooling water ports through which the cooling water inflows and outflows are provided in the first heat exchanger 120. The cooling water ports include a first cooling water inlet hole 123 and a first cooling water outlet hole 124 provided in the lower end and the upper end of the first heat exchanger 120, respectively. The first cooling water inlet hole 123 is a hole through which the cooling water inflows, and the first cooling water outlet hole 124 is a hole through the cooling water heat-exchanged with the coolant outflows. The cooling water exchanges heat with the coolant while flowing in a direction opposite to a flow direction of the coolant (a lower portion to an upper portion).

Since the coolant ports and the cooling water ports described above are disposed separately from each other, the assemblability of coolant piping and cooling water piping can be improved.

The first expansion valve 130 serves to control the expansion of the coolant flowing into the first heat exchanger 120. The first expansion valve 130 may be disposed around the first heat exchanger 120 and may expand or pass the coolant flowing into the thermal management fluid module for a vehicle. The coolant inflowing through the first expansion valve 130 may exchange heat while passing through the first heat exchanger 120 or move to an external heat exchanger.

The coolant outflowing through the first coolant outlet hole 122 of the first heat exchanger 120 flows into the first direction change valve 140. The first direction change valve 140 serves to control a flow direction of the coolant flowing out of the first heat exchanger 120. The coolant flowing into the first direction change valve 140 may move to the external heat exchanger (not shown). In addition, the coolant flowing into the first expansion valve 130 may move to the second direction change valve 150 in a dehumidification mode and then move to an evaporator (not shown).

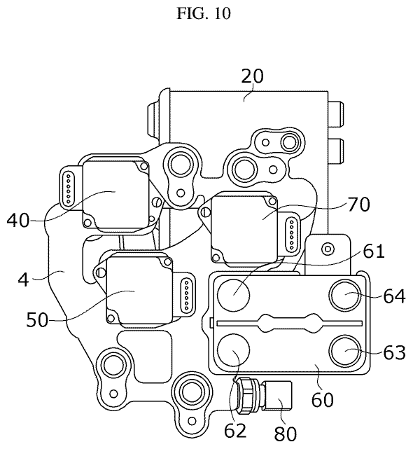

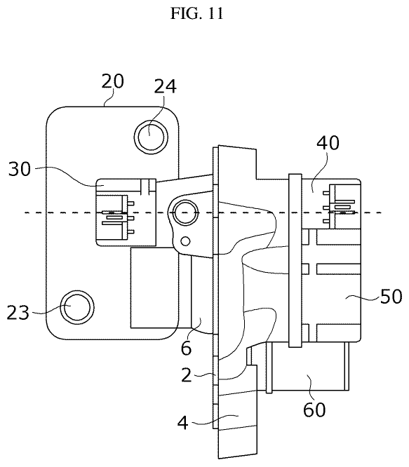

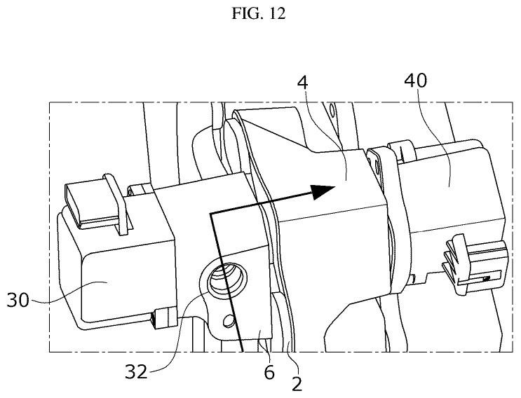

FIG. 10 is a front view illustrating a thermal management fluid module for a vehicle according to another embodiment of the present invention, and FIG. 11 is a side view illustrating the thermal management fluid module for a vehicle according to another embodiment of the present invention. FIG. 12 is a view illustrating a fluid passage between valves in the thermal management fluid module for a vehicle according to another embodiment of the present invention.

Referring to the drawings, since a first expansion valve 130 and a first direction change valve 140 are disposed on both sides of the main plate 102, the first expansion valve 130 and the first direction change valve 140 may be disposed to be horizontally collinear with each other. That is, a coolant inflowing through a valve inlet hole 132 of the first expansion valve 130 passes through the first expansion valve 130 and a communication hole 110 of a main plate 102 and flows into the first direction change valve 140. When a coolant passage is formed as described above, a structure of a passage can be simplified, and the pressure loss occurring while the coolant passes through a relatively long passage can be reduced.

The low-temperature low-pressure coolant is supplied to a second heat exchanger 160 and exchanges heat with cooling water moving along a cooling water circulation line (not shown). The cold cooling water heat-exchanged in the second heat exchanger 160 may exchange heat with a battery by circulating along the cooling water circulation line. The coolant heat-exchanged with the external heat exchanger flows into a second expansion valve 170, and the coolant expanding in the second expansion valve 170 flows into the second heat exchanger 160. The coolant heat-exchanged in the second heat exchanger 160 outflows through a lower end thereof and flows into an accumulator (not shown).

Referring to FIG. 10, coolant ports through which the coolant inflows and outflows are provided in the second heat exchanger 160. The coolant ports include a second coolant inlet hole 161 and a second coolant outlet hole 162 provided at an upper end and the lower end of the second heat exchanger 160, respectively. The second coolant inlet hole 161 is a hole through which the coolant inflows, and the second coolant outlet hole 162 is a hole through which the coolant heat-exchanged in the second heat exchanger 160 outflows.

In the present embodiment, the second coolant inlet hole 161 and the second coolant outlet hole 162 may be formed in a second coolant flange 160F integrally formed at one side of the second heat exchanger 160. As the second coolant inlet hole 161 is disposed at a higher level than the second coolant outlet hole 162, the coolant can flow in a gravity direction. Accordingly, a trapping phenomenon that the coolant and oil remain in the thermal management fluid module can be prevented.

In this case, in consideration of thermal interference, the second coolant inlet hole 161 of the second heat exchanger 160 may be formed at one side close to the second expansion valve 170, and the second coolant outlet hole 162 may be formed at the other side thereof far from the second expansion valve 170. More specifically, the second coolant inlet hole 161 may be disposed closer to the second expansion valve 170 than the second coolant outlet hole 162. For example, a distance from the second expansion valve 170 to the second coolant inlet hole 161 may be smaller than a distance from the second expansion valve 170 to the second coolant outlet hole 162.

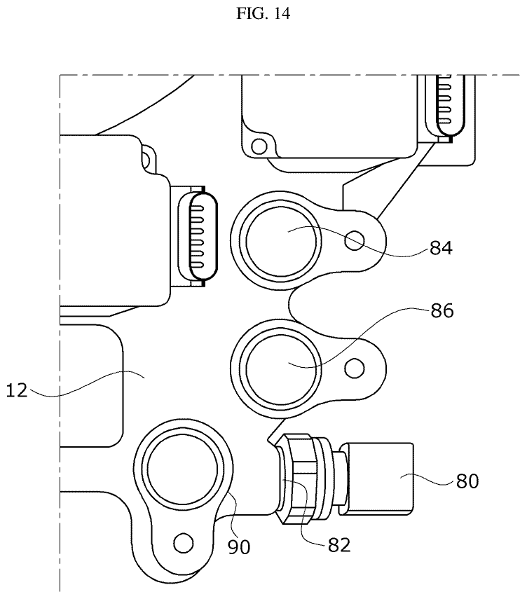

Referring to FIG. 14, a sensor 180 (for example, a platinum (PT) sensor) that measures a temperature and a pressure of the coolant may be disposed in a low-temperature passage through which the coolant flowing out of the second heat exchanger 160 flows. This is for detecting an exact state (a temperature and a pressure) of the coolant flowing out of the second heat exchanger 160 and improve the controllability of a chiller expansion valve (not shown).

The sensor 180 may be coupled to a side surface of the manifold plate 101. That is, the sensor 180 may be mounted on a side surface of the first plate 104, that is, one surface coplanar with the second heat exchanger 160 to detect the state of the coolant. Meanwhile, a mounting portion of the sensor 180 described above is one example thereof, and the sensor 180 may also be coupled to an upper surface of the first plate 104.

In addition, an entrance hole 184 of the second coolant inlet hole 161, an exit hole 186 of the second coolant outlet hole 162, and a sensor insertion hole 182 into which the sensor 180 is inserted, which are formed in the first plate 104, may be disposed in the gravity direction. The entrance hole 184 and the exit hole 186 are formed in the second coolant inlet hole 161 and the second coolant outlet hole 162, and the sensor insertion hole 182 for coupling of the sensor 180 is formed in the first plate 104.

In the drawings, the entrance hole 184 and the exit hole 186 are not formed to overlap the sensor 180 in a vertical direction, but the entrance hole 184 and the exit hole 186 may be formed to overlap the sensor 180 in the vertical direction.

In addition, as an accumulator port 190, which is a port through which the coolant finally flows out of the thermal management fluid module for a vehicle, is provided at a lowermost end in the gravity direction, a trap phenomenon that the coolant and oil remain in the thermal management fluid module can be prevented.

According to one embodiment of the present invention, since both a ball-type direction change valve (3-way valve) and a needle-type expansion valve can be mounted on a manifold plate, a thermal management fluid module for a vehicle can be packaged, product workability can be improved, and thus costs can be reduced.

In addition, according to one embodiment of the present invention, since a valve mounted on a manifold plate does not interfere with a fluid passage formed in a manifold, the airtightness of a thermal management fluid module for a vehicle can be maintained.

In addition, according to one embodiment of the present invention, the space efficiency of a thermal management fluid module for a vehicle can be improved by appropriately designing an entrance and exit structure through which a fluid inflows according to a type (ball type or needle type) of valve.

In addition, according to one embodiment of the present invention, optimal modularization can be implemented by providing a coolant passage on each of one surface and the other surface of a manifold plate and arranging a heat exchanger, a valve, and the like on the coolant passage.

In addition, according to one embodiment of the present invention, since valves disposed on both surfaces of a manifold plate communicate to allow a fluid to directly flow therebetween so that a shortest coolant passage is formed, the pressure loss and thermal interference between passages can be minimized to prevent thermal management performance degradation.

In addition, according to one embodiment of the present invention, by forming a coolant passage so that a coolant flows in a gravity direction, the coolant and oil can be prevented from remaining in a manifold plate.

While the present invention has been described above with reference to specific embodiments, it may be understood by those skilled in the art that various modifications and changes of the present invention may be formed within a range not departing from the spirit and scope of the present invention defined by the appended claims.

1. A thermal management fluid module for a vehicle, comprising:
a manifold plate, in which a fluid passage is formed in one surface of the manifold plate, and the fluid passage is formed along one passage layer; and
a valve which is coupled to another surface of the manifold plate and expands a fluid or controls a flow direction of the fluid,
wherein the valve is disposed on a layer different from the passage layer of the fluid passage and communicates with the fluid passage.

2. The thermal management fluid module for a vehicle of claim 1, wherein the valve is disposed in a layer above the passage layer of the fluid passage.

3. The thermal management fluid module for a vehicle of claim 1, further comprising a heat exchanger which is coupled to the manifold plate and exchanges heat between a coolant and cooling water.

4. The thermal management fluid module for a vehicle of claim 3, wherein:
the valve is a direction change valve which controls a flow direction of the coolant flowing out of the heat exchanger; and
the direction change valve is coupled to a first valve seating part formed on the layer above the passage layer on the one surface of the manifold plate.

5. The thermal management fluid module for a vehicle of claim 4, wherein:
a first inlet hole through which the coolant flowing through the fluid passage flows is formed in a bottom surface of the first valve seating part; and
a first outlet hole through which the coolant flowing into the direction change valve outflows is formed in a side surface of the first valve seating part.

6. The thermal management fluid module for a vehicle of claim 4, wherein:
a flange part is provided on the direction change valve; and
the flange part is fastened to a valve fastening part formed on an upper end of the first valve seating part.

7. The thermal management fluid module for a vehicle of claim 3, wherein:
the valve is an expansion valve which expands the coolant flowing into the heat exchanger; and
the expansion valve is coupled to a second valve seating part formed on the layer above the passage layer in the one surface of the manifold plate.

8. The thermal management fluid module for a vehicle of claim 7, wherein a second inlet hole through which the coolant flows into the expansion valve is formed in a side surface of the second valve seating part.

9. The thermal management fluid module for a vehicle of claim 7, wherein a second outlet hole through which the coolant flowing into the expansion valve outflows is formed in a bottom surface of the second valve seating part.

10. A thermal management fluid module for a vehicle, comprising:
a manifold plate in which a passage through which a fluid flows is formed; and
valves which are coupled to one surface and the other surface of the manifold plate and expand the fluid or control a flow direction of the fluid,
wherein the valve coupled to the one surface of the manifold plate communicates with the valve coupled to the other surface of the manifold plate so that the fluid flowing out of the valve coupled to the one surface directly flows into the valve coupled to the other surface.

11. The thermal management fluid module for a vehicle of claim 10, wherein the manifold plate includes:
a main plate;
a first plate which is coupled to one surface of the main plate and in which a passage through which the fluid flows is formed; and
a second plate which is coupled to the other surface of the main plate and in which a passage through which the fluid flows is formed,
wherein a communication hole for passage communication between the valves coupled to the first plate and the second plate is formed in the main plate.

12. The thermal management fluid module for a vehicle of claim 11, wherein the second plate is coupled to:
a first heat exchanger in which the fluid flows to perform heat exchange; and
a first expansion which expands or passes the fluid flowing into the first heat exchanger.

13. The thermal management fluid module for a vehicle of claim 12, wherein the first plate is coupled to:
a second heat exchanger in which the fluid flows to perform heat exchange;
a first direction change valve and a second direction change valve which control a flow direction of the fluid flowing out of the first heat exchanger; and
a second expansion valve which expands the fluid flowing into the second heat exchanger.

14. The thermal management fluid module for a vehicle of claim 11, wherein:
the second plate is coupled to a first heat exchanger in which a high-temperature fluid flows; and
the first plate is coupled to a second heat exchanger in which a low-temperature fluid flows.

15. The thermal management fluid module for a vehicle of claim 13, wherein the first expansion valve and the first direction change valve are disposed to be horizontally collinear on the manifold plate.

16. The thermal management fluid module for a vehicle of claim 13, wherein a sensor which measures a temperature and a pressure of a coolant is disposed on a passage through which the coolant flowing out of the second heat exchanger flows.

17. The thermal management fluid module for a vehicle of claim 16, wherein an entrance hole through which the coolant flows into the second heat exchanger, an exit hole through which the coolant outflows, and a sensor insertion hole into which the sensor is inserted are disposed in a gravity direction.

18. The thermal management fluid module for a vehicle of claim 16, wherein the sensor is coupled to the one surface, which is the same as a surface coupled to the second heat exchanger, of the manifold plate.

19. The thermal management fluid module for a vehicle of claim 16, wherein:
the second heat exchanger is coupled to the one surface of the manifold plate; and
the sensor is coupled to a side surface of the manifold plate.

20. The thermal management fluid module for a vehicle of claim 10, wherein an accumulator port through which the fluid outflows to an accumulator is formed in a lowermost end of the manifold plate in the gravity direction.
